(19) United States
(12) Patent Application Publication
(10) Pub. No.: US 2018/0200951 A1
(43) Pub. Date: Jul. 19, 2018

(54) THREE-DIMENSIONAL OBJECT FORMING APPARATUS, THREE-DIMENSIONAL OBJECT FORMING METHOD, FORMATION INTERMEDIATE PRODUCT, AND THREE-DIMENSIONAL OBJECT

(71) Applicant: MIMAKI ENGINEERING CO., LTD., Nagano (JP)

(72) Inventor: Kazuhiro OCHI, Nagano (JP)

(21) Appl. No.: 15/865,741

(22) Filed: Jan. 9, 2018

(30) Foreign Application Priority Data
Jan. 17, 2017 (JP) 2017-006080

(51) Int. Cl. B29C 64/194; B29C 64/227; B29C 64/112; B29C 64/393; B29C 64/205; B33Y 10/00; B33Y 30/00

(52) U.S. Cl. CPC B29C 64/194; B29C 64/227; B29C 64/112; B29C 64/393; B29K 2995/0072; B33Y 10/00; B33Y 30/00; B29K 2995/0022; B29C 64/205

(57) ABSTRACT

A three-dimensional-object forming apparatus generates a three-dimensional object such that from a formation intermediate product obtained by sequentially depositing unit layers each including a build material and/or a support material on a work surface, a support made of the support material is removed. The three-dimensional-object forming apparatus includes a position determiner and a roughener. The position determiner determines a position of the build material and a position of the support material to make a partial surface contact between the three-dimensional object and the support. The roughener roughens a specific area defined by an outer surface among outer surfaces of the build material located at the position determined by the position determiner. The outer surface is parallel with the work surface.

### CROSS-REFERENCE TO RELATED APPLICATIONS

The present application claims priority under 35 U.S.C. § 119 to Japanese Patent Application No. 2017-006080, filed Jan. 17, 2017. The contents of this application are incorporated herein by reference in their entirety.

### BACKGROUND

### Field of the Invention

The present disclosure relates to a three-dimensional object forming apparatus and a three-dimensional object forming method. The present disclosure also relates to a formation intermediate product and a three-dimensional object formed by this method.

### Discussion of the Background

Some recently developed three-dimensional object forming apparatuses (what are known as 3D printers) form a three-dimensional object by solidifying and sequentially depositing unit layers along a vertical direction. The apparatuses use a “build material” for forming an object and a “support material” for maintaining the shape of the object to form a formation intermediate product. Then, the support material is removed from the formation intermediate product to obtain a desired object (see the Abstract of JP2012-96428A1)

The contents of JP2012-96428A1 (Abstract) are incorporated herein by reference in their entirety.

The present inventor has found that local surface glossiness variation occurs due to the outer shape of an object. Specifically, a surface in contact with the support material is likely to have lower glossiness than a surface not in contact with the support material.

Furthermore, an object is likely to have lower glossiness (mat tone) on a side surface that has been in contact with the support material than on a top surface or a bottom surface that has also been in contact with the support material.

JP2012-96428A1 remains silent about the local glossiness as well as the disadvantages of the variation. Thus, an object formed by the apparatus and the method disclosed in JP2012-96428A1 has a surface with local texture variation, resulting in an observer feeling unnatural.

The embodiments of the present disclosure have been made in view of the above-described circumstances, and it is an object of the present disclosure to provide a three-dimensional object forming apparatus and a three-dimensional object forming method ensuring higher finished quality in terms of surface glossiness regardless of an outer shape of an object to be formed, and to provide a formation intermediate product and a three-dimensional object with higher finished quality in terms of the surface glossiness.

### SUMMARY

According to one aspect of the present disclosure, a three-dimensional object forming apparatus forms a three-dimensional object in such a manner that from a formation intermediate product obtained by sequentially depositing unit layers each including a build material and/or a support material on a work surface, a support made of the support material is removed, whereby the three-dimensional object is made of the build material, and includes a position determiner and a roughener. The position determiner is configured to determine a position of the build material and a position of the support material so as to make a partial surface contact between the three-dimensional object and the support. The roughener is configured to roughen a specific area defined by an outer surface among outer surfaces of the build material located at the position determined by the position determiner. The outer surface is parallel with the work surface.

The roughness of the outer surface formed of the build material might change in accordance with the positional accuracy of the build material and/or the support material or the positional relationship between the materials. For example, the specific area with the surface in parallel with the work surface is formed only of a single unit layer. Thus, the specific area generally has high positional accuracy of the build material, and thus is likely to have a relatively small surface roughness. The contact area, where the build material and the support material come into surface contact with each other, has a microscopically nonuniform interface due to an interface phenomenon between the materials. This nonuniform interface is exposed as a surface with large roughness after the support material is removed. An area inclined with respect to the work surface is likely to have a low positional accuracy due to gravity or quantization error, and thus is likely to have a large surface roughness.

Thus, the roughener is provided to roughen the specific area so that the difference in the surface roughness between the specific area and the contact area can be reduced. This facilitates an attempt to achieve uniform glossiness of the outer surface at least between these areas. This ensures higher finishing quality in terms of surface glossiness, regardless of the outer shape of an object.

The roughener preferably roughens the specific area not covered with the support material. The specific area not covered with the support material is likely to have a small surface roughness. Thus, the glossiness of the specific area is likely to standout. In view of this, the specific area is roughened to reduce the local glossiness, whereby an observer is less likely to feel unnatural.

The roughener preferably roughens the specific area adjacent to an area covered with the support material. As described above, the area covered with the support material is likely to have a large surface roughness. When the area adjacent to the specific area has a large surface roughness, the glossiness of the specific area might visibly standout due to what is known as simultaneous contrast effect. Thus, the specific area is roughened so that the simultaneous contrast effect is less likely to occur, whereby an observer is less likely to feel unnatural.

An ejection unit configured to eject droplets of the build material and the support material is preferably provided, and the roughener may be an ejection controller configured to control the ejection unit to set at least one of an ejection density, an ejection amount, and an ejection speed of the droplets for the specific area to be nonuniform. Thus, the specific area can be roughened in the processing of controlling the ejection unit.

An ejection unit configured to eject droplets of the build material and the support material is preferably provided, and the roughener may be a data corrector configured to set ejection data used for ejection control for the ejection unit to be nonuniform for the specific area. Thus, the specific area can be roughened in the processing of generating the ejection data.

The roughener is preferably a position corrector configured to additionally arrange the support material at a position to cover the specific area. Thus, the specific area can be roughened in the processing of arranging the build material and the support material.

According to another aspect of the present disclosure, a three-dimensional object forming method uses a three-dimensional object forming apparatus that is configured to form a three-dimensional object in such a manner that from a formation intermediate product obtained by sequentially depositing unit layers each including a build material and/or a support material on a work surface, a support made of the support material is removed, whereby the three-dimensional object is made of the build material. A position of the build material and a position of the support material are determined so as to make a partial surface contact between the three-dimensional object and the support. A specific area defined by an outer surface among outer surfaces of the build material located at the position determined by the position determiner is roughened. The outer surface is parallel with the work surface.

The roughening step preferably includes roughening the specific area not covered with the support material.

The roughening step preferably includes roughening the specific area adjacent to an area covered with the support material.

Preferably, ejecting droplets of the build material and the support material with an ejection unit of the three-dimensional object forming apparatus is further performed, and the roughening step may include controlling the ejection unit to set at least one of an ejection density, an ejection amount, and an ejection speed of the droplets for the specific area to be nonuniform.

Preferably, ejecting droplets of the build material and the support material with an ejection unit of the three-dimensional object forming apparatus is further performed, and the roughening step may include setting ejection data used for ejection control for the ejection unit to be nonuniform for the specific area.

The roughening step preferably includes additionally arranging the support material at a position to cover the specific area.

According to one aspect of the present disclosure, a formation intermediate product is formed by using the three-dimensional object forming method described above. According to the aspect of the present disclosure, a three-dimensional object is formed by using the three-dimensional object forming method described above.

The three-dimensional object forming apparatus, the three-dimensional object forming method, and the formation intermediate product according to the embodiments of the present disclosure ensure higher finishing quality in terms of surface glossiness regardless of the outer shape of an object. The three-dimensional object according to the embodiments of the present disclosure features high finishing quality in terms of surface glossiness.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIGS. 1A and 1B are schematics illustrating a main part of a three-dimensional object forming apparatus common to embodiments;

FIG. 2 is an electrical block diagram of a three-dimensional object forming apparatus according to a first embodiment;

FIGS. 3A and 3B illustrate a configuration of a three-dimensional object and a configuration of a formation intermediate product;

FIG. 4 is a flowchart of how the three-dimensional object forming apparatus illustrated in FIG. 2 operates;

FIG. 5 is a schematic view illustrating a result of extracting specific areas;

FIGS. 6A to 6C are diagrams illustrating how nonuniform ejection control conditions are set;

FIGS. 7A and 7B are partially enlarged cross-sectional views of portions of the formation intermediate product close to the specific areas;

FIG. 8 is an electrical block diagram of a three-dimensional object forming apparatus according to a second embodiment;

FIG. 9 is a flowchart of how the three-dimensional object forming apparatus illustrated in FIG. 8 operates;

FIGS. 10A to 10C are diagrams illustrating how ejection data is set to be nonuniform;

FIG. 11 is an electrical block diagram of a three-dimensional object forming apparatus according to a third embodiment;

FIG. 12 is a flowchart of how the three-dimensional object forming apparatus illustrated in FIG. 11 operates; and

FIG. 13 is a diagram illustrating how an additional support material is arranged.

### DESCRIPTION OF THE EMBODIMENTS

Embodiments of a three-dimensional object forming apparatus according to the embodiments of the present disclosure are described below in relation to a three-dimensional object forming method, a formation intermediate product, and a three-dimensional object with reference to the accompanying drawings.

### Main Configuration of Three-dimensional Object Forming Apparatus 10

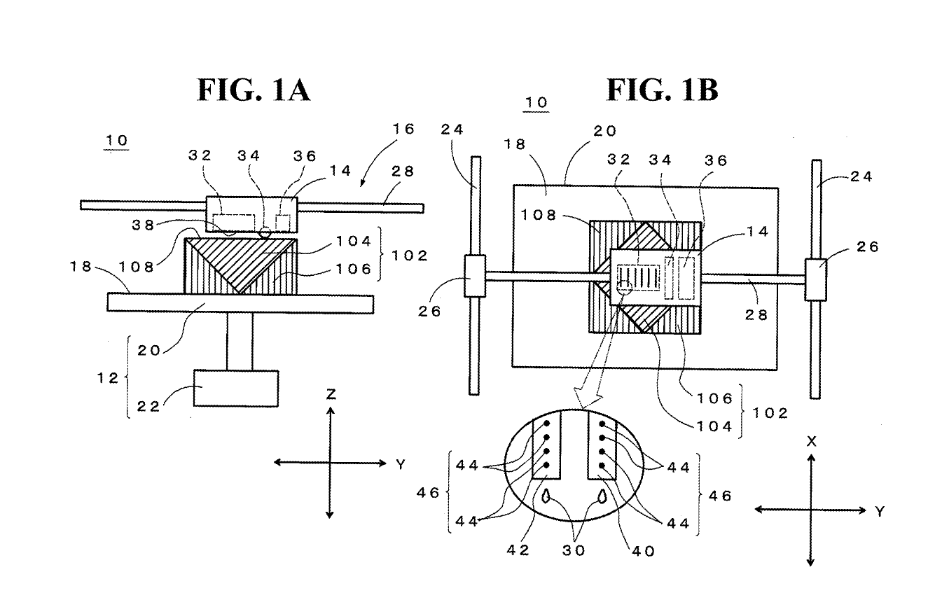

FIGS. 1A and 1B are schematics illustrating main components and/or elements of a three-dimensional object forming apparatus 10 common to embodiments described below. Specifically, FIG. 1A is a schematic side view of a three-dimensional object forming apparatus 10. FIG. 1B is a schematic plan view of the three-dimensional object forming apparatus 10. Referring to FIGS. 1A and 1B, a slice multilayer structure 102 is a three-dimensional object 100 in the formation stage

The slice multilayer structure 102 is made up of a build material 104 and a support material 106. The build material 104 is a material of the three-dimensional object 100. The support material 106 supports the build material 104 internally and/or externally. That is, the slice multilayer structure 102 is formed by sequentially depositing unit layers (hereinafter, also referred to as “slice layers”), including the build material 104 and/or the support material 106, in the vertical direction. The top surface of the slice multilayer structure 102 may be hereinafter referred to as a “slice surface 108”.

The three-dimensional object forming apparatus 10 includes a stage unit 12, a carriage 14, and a carriage driver 16. On the stage unit 12, the multilayer structure 102 is placed. The carriage 14 includes an ejection mechanism that ejects the build material 104 and the support material 106. The carriage driver 16 drives the carriage 14 in the X direction and the Y direction.

The stage unit 12 includes a stage 20 and a stage driver 22. The stage 20 has a flat working surface 18. The stage driver 22 causes the stage 20 to move in the normal direction (Z direction) of the working surface 18. The carriage driver 16 includes pair of guide rails 24 and 24 (X bars), two sliders 26 and 26, and a carriage rail 28 (Y bar). The pair of guide rails 24 and 24 extend in parallel to each other in the X direction. The two sliders 26 and 26 are movable along the respective guide rails 24. The carriage rail 28 extends in the Y direction and connects the two sliders 26 and 26 to each other.

The carriage 14 is mounted on the carriage rail 28 and movable along the carriage rail 28 or movable along the guide rails 24 and 24 together with the carriage rail 28. This configuration enables the carriage 14 and the stage 20 to move relative to each other in the X direction, the Y direction, and the Z direction, which cross each other. In this embodiment, the X direction, the Y direction, and the Z direction are approximately orthogonal to each other with the X direction and the Y direction corresponding to the “horizontal direction” and the Z direction corresponding to the “vertical direction”.

The carriage 14 includes an ejection unit 32, a flattening roller 34, and a curing unit 36. The ejection unit 32 ejects a flowable build material 104 and a flowable support material 106 (hereinafter, also collectively referred to as a “droplet 30”) toward the work surface 18. The flattening roller 34 flattens the slice surface 108. The curing unit 36 cures the droplet 30 on the slice surface 108.

An ejection surface 38 of the ejection unit 32 is the lower surface of the ejection unit 32 facing the working surface 18 or the slice surface 108. The ejection unit 32 includes a plurality of ejection heads 40 and a single ejection head 42. The plurality of ejection heads 40 eject the same or different colors of build materials 104. The ejection head 42 ejects the support material 106. The ejection heads 40 and 42 may have any type of ejection mechanism to eject the droplets 30. A possible type of ejection mechanism ejects the droplets 30 using a modified actuator provided with a piezoelectric element. Another possible type of ejection mechanism generates air bubbles by heating the build material 104 or the support material 106 using a heater (heat generator) and ejects the droplets 30 using the pressure of the air bubbles.

On the surfaces of the ejection heads 40 and 42 facing the ejection surface 38, nozzle arrays 46 are disposed. In each nozzle array 46, a plurality of nozzles 44 are aligned in an alignment direction (which is the X direction in FIGS. 1A and 1B). When there are six ejection heads 40 on the ejection unit 32, the six ejection heads 40 may eject, for example, a droplet 30 of build material 104 colored in cyan (C), a droplet 30 of build material 104 colored in magenta (M), a droplet 30 of build material 104 colored in yellow (Y), a droplet 30 of build material 104 colored in black (K), a droplet 30 of build material 104 colored in clear (CL), and a droplet 30 of build material 104 colored in white (W).

The curing unit 36 cures the droplets 30 of build material 104 by applying various kinds of energy to the droplets 30. For example, when the build material 104 is ultraviolet curable resin, the curing unit 36 includes an ultraviolet optical source that radiates ultraviolet light, which is light energy. For further example, when the build material 104 is thermoset resin, the curing unit 36 includes: a heating device that applies heat energy; and, as necessary, a cooling device that cools the multilayer structure 102.

Examples of the ultraviolet optical source include, but are not limited to, a rare-gas discharge lamp, a mercury discharge lamp, a fluorescent lamp, and an LED (Light-Emitting Diode) array. The support material 106 is made of a material removable without alteration in quality of the three-dimensional object 100. Examples of such material include, but are not limited to, a water swellable gel, a wax, a thermoplastic resin, a water soluble material, and a soluble material.

### First Embodiment

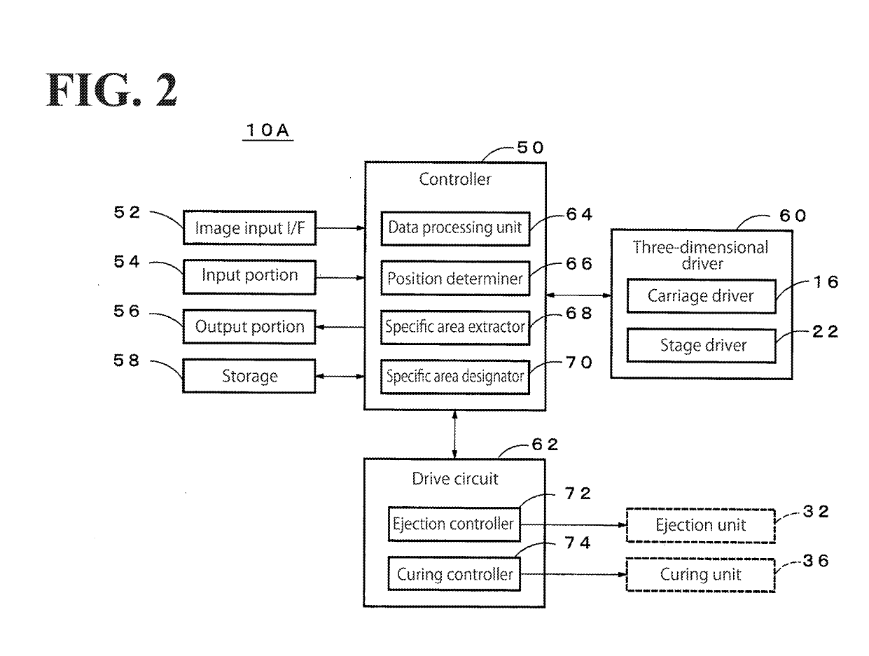

A three-dimensional object forming apparatus 10A according to a first embodiment will be described below by referring to FIGS. 2 to 7. Electrical block diagram of three-dimensional object forming apparatus 10A

FIG. 2 is an electrical block diagram of the three-dimensional object forming apparatus 10A according to the first embodiment. The three-dimensional object forming apparatus 10A includes the carriage driver 16, the stage driver 22, the ejection unit 32, and the curing unit 36 illustrated in FIGS. 1A and 1B, and further includes a controller 50, an image input I/F 52, an input portion 54, an output portion 56, a storage 58, a three-dimensional driver 60, and a drive circuit 62.

The image input I/F 52 is a serial I/F or a parallel I/F, and receives an electrical signal from an external apparatus or device, not illustrated. The electrical signal includes image information about the three-dimensional object 100. The input portion 54 includes a mouse, a keyboard, a touch sensor or a microphone. The output portion 56 includes a display or a speaker.

The storage 58 is a non-transitory and computer-readable storage medium. Examples of the computer-readable storage medium include, but are not limited to: a transportable medium such as a light magnetic disc, a ROM, a CD-ROM, and a flash memory; and a hard disc built in a computer system. Also, the storage medium may hold a program for a short period of time and in a dynamic manner, or may hold a program for a predetermined, longer period of time.

The three-dimensional driver 60 drives at least one of the stage 20 and the ejection unit 32 to cause the ejection unit 32 to move relative to the stage 20 in a three-dimensional direction. In this embodiment, the three-dimensional driver 60 includes the carriage driver 16 and the stage driver 22. The carriage driver 16 causes the ejection unit 32 to move in the X direction and the Y direction. The stage driver 22 causes the stage 20 to move in the Z direction.

The controller 50 is an arithmetic and/or logic operation device that controls the components and/or elements of the three-dimensional-object forming apparatus 10. Examples of the controller 50 include, but are not limited to, a central processing unit (CPU) or a micro-processing unit (MPU). The controller 50 is capable of implementing various functions, including a data processing unit 64, a position determiner 66, a specific area extractor 68, and a specific area designator 70, by reading and executing a program stored in the storage 58.

The drive circuit 62 is an electric circuit that is electrically connected to the controller 50 and that drives the following units to execute formation processing. In this embodiment, the drive circuit 62 includes an ejection controller 72 (roughener) and a curing controller 74. The ejection controller 72 controls the ejection by the ejection unit 32. The curing controller 74 controls the curing by the curing unit 36.

Based on ejection data supplied from the controller 50, the ejection controller 72 generates drive waveform signals for actuators disposed in the ejection heads 40 and 42, and outputs the waveform signals to the ejection unit 32. The curing controller 74 generates a driving signal for applying various types of energy, and outputs this driving signal to the curing unit 36.

### Configuration of Three-dimensional Object 100 and Configuration of Formation Intermediate Product 120

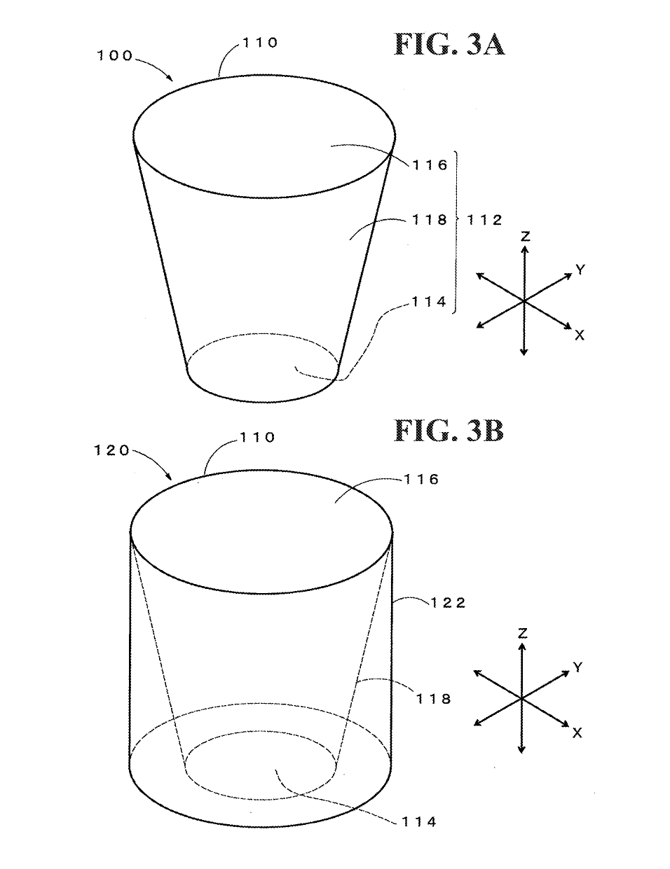

FIGS. 3A and 3B illustrate a configuration of the three-dimensional object 100 and a configuration of a formation intermediate product 120. Specifically, FIG. 3A is a front view of the three-dimensional object 100, and FIG. 3B is a front view of the formation intermediate product 120. The formation intermediate product 120 corresponds to the slice multilayer structure 102 in complete state. That is, the formation intermediate product 120 is an object with the support material 106 (the support 122) not removed yet.

As illustrated in FIG. 3A, the three-dimensional object 100, which is made of the build material 104, includes a body 110. The body 110 has an inverse truncated cone shape. Outer surfaces 112 of the body 110 include a circular bottom surface 114, an upper surface 116, and a side surface 118. The upper surface 116 is greater in diameter than the bottom surface 114. The side surface 118 connects the bottom surface 114 and the upper surface 116 to each other.

The body 110 is made of a material that is curable by physical treatment or chemical treatment. Examples of such material include, but are not limited to, photocurable resin and thermoset resin. Thus, the material may be ultraviolet curable resin that cures upon being irradiated with ultraviolet (UV) light. This curable resin may be radical-polymerization resin, cured by radical polymerization reaction, or cationic polymerization resin, cured by cationic polymerization reaction. Examples of the radical polymerization ultraviolet curable resin include, but are not limited to, urethane acrylate, alkyl acrylate, and epoxy acrylate.

As illustrated in FIG. 3B, the formation intermediate product 120 includes the body 110 and a support 122. The support 122 externally supports the body 110. The support 122 has an approximately cup shaped recess, and entirely covers the bottom surface 114 and the side surface 118. The support 122 is made of a material that can be removed without modifying the three-dimensional object 100. Examples of such material include, but are not limited to, water-swelling gel, wax, thermoplastic resin, a water-soluble material, a soluble material.

The bottom surface 114, the top surface 116, and the side surface 118 have approximately the same level of surface roughness, and have approximately uniform glossiness. The term “surface roughness” as used herein is a physical amount that is defined by JISB0601 (1994) and JISB0031 (1994) and is at least one of calculated average roughness (Ra), maximum height (Ry), 10-point average roughness (Rz), mean interval of surface roughness (Sm), mean interval of local peaks (S), and load length ratio (tp).

### Operation of Three-dimensional Object Forming Apparatus 10A

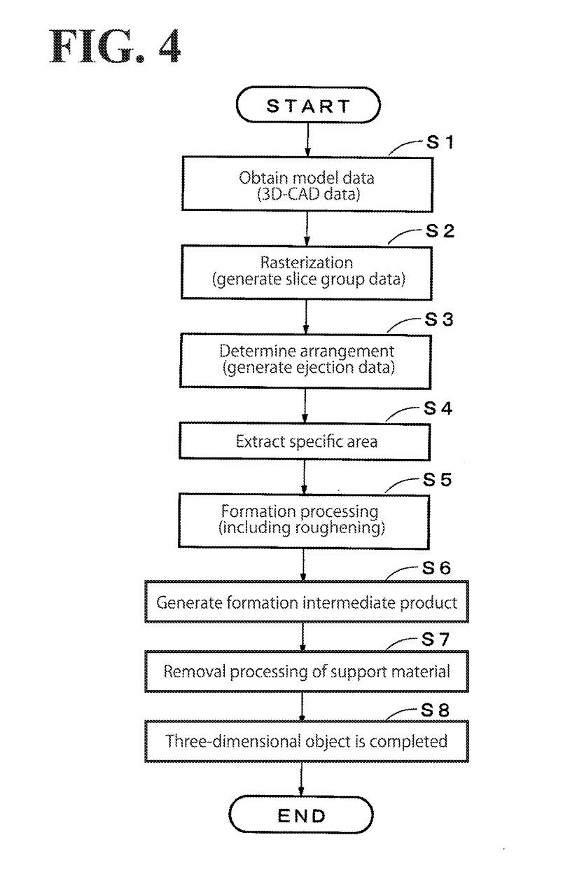

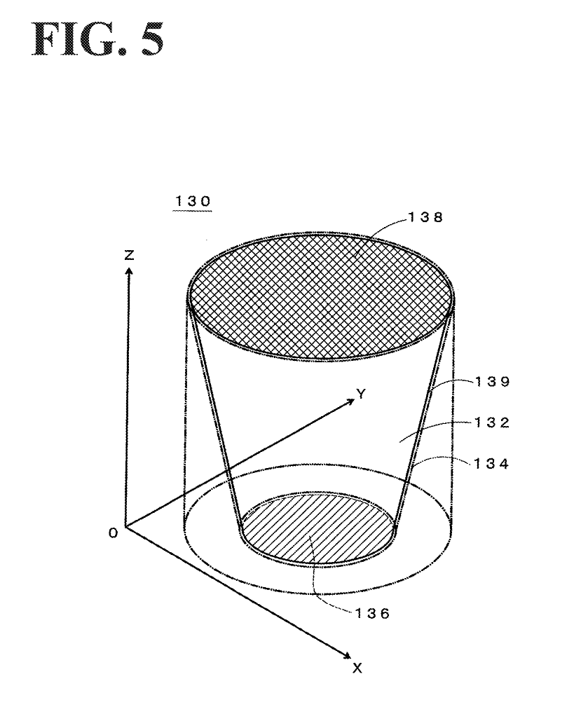

By referring to the flowchart illustrated in FIG. 4 and by referring to FIGS. 5 to 7, description will be made with regard to an operation of the three-dimensional object forming apparatus 10A illustrated in FIG. 2 and an operation to generate the three-dimensional object 100 illustrated in FIG. 3A.

At step S1 of FIG. 4, the controller 50 obtains through the image input I/F 52 model data that includes 3D-CAD (Computer Aided Design) data. For example, the model data may be a wire frame model, which may be a combination of: shape model data of a three-dimensional frame of the three-dimensional object 100; and surface image data of an image of the outer surfaces 112. It will be understood that the wire frame model is not intended as limiting the form of the model data. Other examples include a surface model and a solid model.

At step S2, the data processing unit 64 rasterizes the vector model data obtained at step S1. Prior to the rasterization, the data processing unit 64 defines a work area 130 (FIG. 5), which is a three-dimensional space in the X direction, the Y direction, and the Z direction, and determines three-dimensional resolutions (in relation to actual dimensions) on the X axis, the Y axis, and the Z axis defining the work area 130.

Next, the data processing unit 64 identifies a color within the frame (for example, white) and applies a surface image to the frame surface using a known method of texture mapping. Then, the data processing unit 64 converts vector data with the surface image into raster data that is based on the three-dimensional resolutions. Further, the data processing unit 64 performs various kinds of image processing such as: half-toning including dithering and error diffusion; classification between similar colors and different colors; dot size (ejection amount) assignment; and putting restriction on the number of droplet hittings. In this manner, slice data of each of the unit layers 141 to 147, which are deposited on one another in one direction (Z axis), is obtained (slice data of the unit layers 141 to 147 will be hereinafter referred to as “slice group data”).

At step S3, the position determiner 66 determines the position of the build material 104 and the position of the support material 106 using the slice group data obtained at step S2. Specifically, the position determiner 66 arranges the support material 106 at a position at which the support material 106 is able to physically support the build material 104 during the process of generating the formation intermediate product 120. In this positioning processing, “ejection data” is generated. The ejection data specifies the presence and absence of droplets 30 and the kind of droplets 30 for each three-dimensional position.

In the example illustrated in FIG. 3A, the side surface 118 of the body 110 forms a protruding outer wall similar to eaves (hereinafter referred to as overhang). When an overhang is formed by depositing the unit layers 141 to 147 upward in the vertical direction, the build material 104 protruding outward may not be physically strong enough to keep its shape and may fall over under the build material 104′s own weight. In light of the circumstances, it is necessary to arrange the support material 106 between the working surface 18 and the side surface 118 so as to reinforce and support portions of the side surface 118 from below the portions of the side surface 118.

At step S4, the specific area extractor 68 extracts two-dimensional areas (hereinafter, referred to as specific areas 136 and 138) that are surfaces, of the outer surface 112 formed of the build material 104 located at the position determined at step S3, in parallel with the work surface 18. The specific areas thus extracted are each formed of a single unit layer and have a relatively small surface roughness.

FIG. 5 is a schematic view illustrating a result of extracting the specific areas 136 and 138. The figure illustrates a state where a virtual object, representing the formation intermediate product 120, is arranged in the work area 130. The work area 130 is a virtual space defined by the “X axis”, the “Y axis”, and the “Z axis”, respectively corresponding to the “X direction”, “Y direction”, and the “Z direction” illustrated in FIGS. 1A and 1B and FIG. 3, with a given reference position (one of end points, for example) serving as an “origin O”.

A closed space illustrated with solid lines represents a build area 132 indicating the three-dimensional position of the build material 104. A closed space illustrated with broken lines represents a support area 134 indicating the three-dimensional position of the support material 106. The work surface 18 is positioned to be in parallel with an X axis-Y axis plane and to be orthogonal with the Z axis in the work area 130.

The specific area extractor 68 extracts the specific areas 136 and 138 that are two two-dimensional areas corresponding to the bottom surface 114 and the top surface 116 (FIG. 3) parallel to the X axis-Y axis plane, from a closed surface defining the build area 132. The specific area extractor 68 obtains positional information on the specific areas 136 and 138 (for example, an identification number of each of the unit layers or the coordinates in the work area 130).

In this configuration, the specific areas 136 and 138 are each extracted without taking the shape and/or the position of the support area 134 into consideration. Alternatively, the areas may be extracted based on relative positional relationship between the build area 132 and the support area 134. For example, the specific area extractor 68 may only extract an area not covered with the support material 106 to be the specific area 138, or may extract areas adjacent to an area covered with the support material 106 to be the specific areas 136 and 138.

At step S5, the three-dimensional object forming apparatus 10A performs formation processing based on the ejection data generated at step S3. Specifically, the three-dimensional object forming apparatus 10A forms the slice multilayer structure 102 by sequentially depositing unit layers 151 to 157, which include the build material 104 and the support material 106, in the Z direction, with the stage 20 and the ejection unit 32 moving relative to each other in the three-dimensional directions. Specifically, the three-dimensional object forming apparatus 10A sequentially performs the following processings. [1] Ejection of the droplets 30 with the ejection unit 32, [2] flattening of the slice surface 108 with the flattening roller 34, [3] curing of the droplets 30 with the curing unit 36, and [4] growth of the slice multilayer structure 102.

The specific area designator 70 performs ejection data transmission processing by transmitting a signal indicating the presence/absence and the positions of the specific areas 136 and 138 to the drive circuit 62 (ejection controller 72). Thus, the ejection controller 72 controls the ejection by the ejection unit 32 to subject the specific areas 136 and 138 to roughening. The term “roughening” as used herein indicates hardware or software processing for increasing surface roughness before/after given processing.

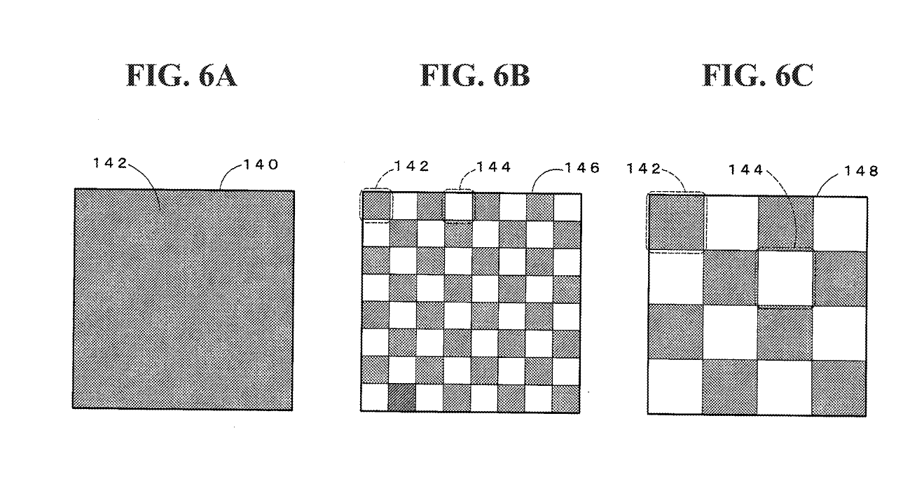

FIGS. 6A to 6C are diagrams illustrating how nonuniform ejection control conditions are set. Specifically, FIG. 6A is a diagram map illustrating an attribute of a normal ejection control condition. FIG. 6B is a first diagram map illustrating an attribute of an ejection control condition during the roughening. FIG. 6C is a second diagram map illustrating an attribute of an ejection control condition during the roughening.

A uniform area 140 illustrated in FIG. 6A is a plane coordinate matrix including 8 (longitudinal direction) x 8 (lateral direction) cells. A hatched cell represents an unchanging position 142 where the ejection control condition does not change, whereas a blank cell represents a changing position 144 where the ejection control condition changes. The uniform area 140 includes no changing position 144, and thus the droplets 30 are ejected under the same ejection control condition (first condition) over the entire uniform area 140.

A nonuniform area 146 illustrated in FIG. 6B includes the unchanging positions 142 and the changing positions 144 arranged in a checkered pattern with a basic unit of each of the areas being “1×1 cell”. In this area, the droplets 30 are ejected onto the unchanging positions 142 under the first ejection control condition, and are ejected onto the changing positions 144 under an ejection control condition (second condition) different from the first condition.

For example, the first condition and the second condition may be different from each other in “whether the droplet is ejected”. This ensures a nonuniform ejection density, thereby increasing a large surface roughness in the nonuniform area 146. The conditions may be different from each other in an “ejection amount”. This ensures a nonuniform ejection amount distribution, thereby increasing surface roughness in the nonuniform area 146. The conditions may be different from each other in “ejection speed”. This ensures a nonuniform height distribution of the droplet 30, thereby increasing a large surface roughness in the nonuniform area 146.

A nonuniform area 148 illustrated in FIG. 6C includes the unchanging positions 142 and the changing positions 144 arranged in a checkered pattern with a basic unit of each of the areas being “2×2 cells”. In this area, the droplets 30 are ejected onto the unchanging positions 142 under the first condition, and are ejected onto the changing positions 144 under the second condition. The checkered pattern illustrated in FIG. 6C has a larger cell size compared with that in FIG. 6B, and thus is likely to result in larger surface roughness.

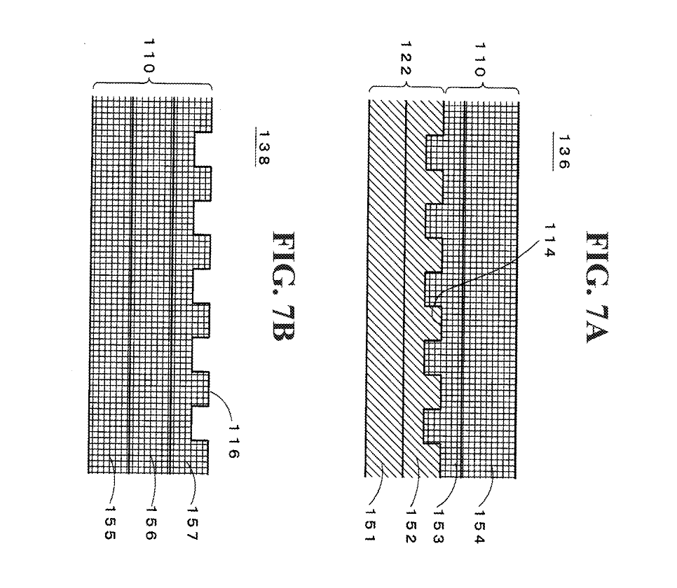

FIGS. 7 A and 7B are partially enlarged cross-sectional views of portions of the formation intermediate product 120 close to the specific areas 136 and 138. Specifically, FIG. 7A is a partially enlarged cross-sectional view of the portion of the formation intermediate product 120 close to the specific area 136. Specifically, FIG. 7B is a partially enlarged cross-sectional view of the portion of the formation intermediate product 120 close to the specific area 138.

As illustrated in FIG. 7A, the portion close to the specific area 136 includes [1] the unit layer 151 made of the support material 106, [2] the unit layer 152 made of the support material 106, [3] the unit layer 153 made of the build material 104, and [4] the unit layer 154 made of the build material 104 that are deposited in this order. In this portion, an interface (that is the bottom surface 114) between the support 122 and the body 110 is roughened with the unit layer 152 designed to have the nonuniform area.

As illustrated in FIG. 7B, the portion close to the specific area 138 includes [5] the unit layer 155 made of the build material 104, [6] the unit layer 156 made of the build material 104, and [7] the unit layer 157 made of the build material 104 that are deposited in this order. In this portion, the top surface 116 roughened is formed with the unit layer 157 designed to have the nonuniform area.

How the roughening is achieved is not limited to the examples illustrated in FIG. 7. For example, the bottom surface 114 may be roughened with the nonuniform area provided not on the unit layer 152 but on the unit layer 153 immediately above the unit layer 152, the unit layer 151 immediately below the unit layer 152, or a unit layer that is a combination of the unit layers 151 to 153. The top surface 116 may be roughened with the nonuniform area provided not on the unit layer 157 but on the unit layer 156 immediately below the unit layer 157 or on both of the unit layers 156 and 157.

As described above, the ejection controller 72 controls the ejection unit 32 to form the specific areas 136 and 138 with at least one of the ejection density, the ejection amount, and the ejection speed of the droplets 30 being nonuniform (step S5).

At step S6, the slice multilayer structure 102 in the completed state is obtained as the formation intermediate product 120 (see FIG. 3B). The formation intermediate product 120 has the bottom surface 114 and the top surface 116 roughened.

At step S7, processing of removing the support material 106 (support 122) from the formation intermediate product 120 obtained at step S6 is performed. This removing processing may be physical processing or chemical processing depending on the property of the support material 106. Specifically, dissolution in water, heating, chemical reaction, washing using water pressure, and electromagnetic radiation may be employed.

At step S8, the three-dimensional object 100 is completed (see FIG. 3A). The bottom surface 114, the top surface 116, and the side surface 118 have approximately the same level of surface roughness, and have approximately uniform glossiness. As a result, higher finishing quality in terms of surface glossiness can be achieved.

The ejection controller 72, serving as the roughener, may execute the roughening on the specific area 138 not covered with the support material 106. The specific area 138 not covered with the support material 106 is likely to have a small surface roughness. Thus, the glossiness of the specific area 138 is likely to standout. In view of this, the specific area 138 is roughened to reduce local glossiness, whereby an observer is less likely to feel unnatural.

The ejection controller 72, serving as the roughener, may execute the roughening on the specific areas 136 and 138, when an area (contact area 139) adjacent to the specific areas 136 and 138 is covered with the support material 106. When the contact area 139 has a large surface roughness, the glossiness of the specific areas 136 and 138 might visibly standout due to what is known as simultaneous contrast effect. Thus, the specific areas 136 and 138 are roughened so that the simultaneous contrast effect is less likely to occur, whereby an observer is less likely to feel unnatural.

### Advantageous Effects Common to the Embodiments

As described above, the three-dimensional object forming apparatus 10 forms the three-dimensional object 100 in such a manner that from the formation intermediate product 120 obtained by sequentially depositing the unit layers 151 to 157 each including the build material 104 and/or the support material 106 on the work surface 18, the support 122 made of the support material 106 is removed, whereby the three-dimensional object 10 is made of the build material 104. The three-dimensional object forming apparatus 10 includes the position determiner 66 and the roughener. The position determiner 66 determines the position of the build material 104 and the position of the support material 106 so as to make a partial surface contact between the three-dimensional object 100 and the support 122. The roughener performs roughening on the specific areas 136 and 138 with the surfaces (the bottom surface 114 and the top surface 116) that are in parallel with the work surface 18, in the outer surface 112 formed of the build material 104 thus arranged.

The roughness of the outer surface 112 formed of the build material 104 might change in accordance with the positional accuracy of the build material 104 and/or the support material 106 or the positional relationship between the materials. For example, the specific area with the surface in parallel with the work surface 18 is formed only of a single unit layer. Thus, the specific area generally has high positional accuracy of the build material 104, and thus is likely to have a relatively small surface roughness. The contact area 139, where the build material 104 and the support material 106 come into surface contact with each other, has a microscopically nonuniform interface due to an interface phenomenon between the materials. This nonuniform interface is exposed as a surface with large roughness after the support material 106 is removed. An area inclined with respect to the work surface 18 is likely to have a low positional accuracy due to gravity or quantization error, and thus is likely to have a large surface roughness.

Thus, the roughener is provided to roughen the specific areas 136 and 138 so that the difference in the surface roughness between the specific areas 136 and 138 and the contact area 139 can be reduced. This facilitates an attempt to achieve uniform glossiness of the outer surface 112 at least between these areas. This ensures higher finishing quality in terms of surface glossiness, regardless of the outer shape of an object.

### Advantageous Effects of Three-dimensional Object Forming Apparatus 10A

The three-dimensional object forming method using the three-dimensional object forming apparatus 10A includes determining the position of the build material 104 and the position of the support material 106 (step S3) and roughening the specific areas 136 and 138 (step S5).

The three-dimensional object forming apparatus 10A further includes the ejection unit 32 that ejects the droplets 30 of the build material 104 and the support material 106. The roughener is the ejection controller 72 that controls the ejection unit 32 to eject the droplets 30, for the specific areas 136 and 138, with at least one of the ejection density, the ejection amount, and the ejection speed of the droplets 30 being nonuniform. Thus, the roughening for the specific areas 136 and 138 is executable in the processing of controlling the ejection unit 32.

### Second Embodiment

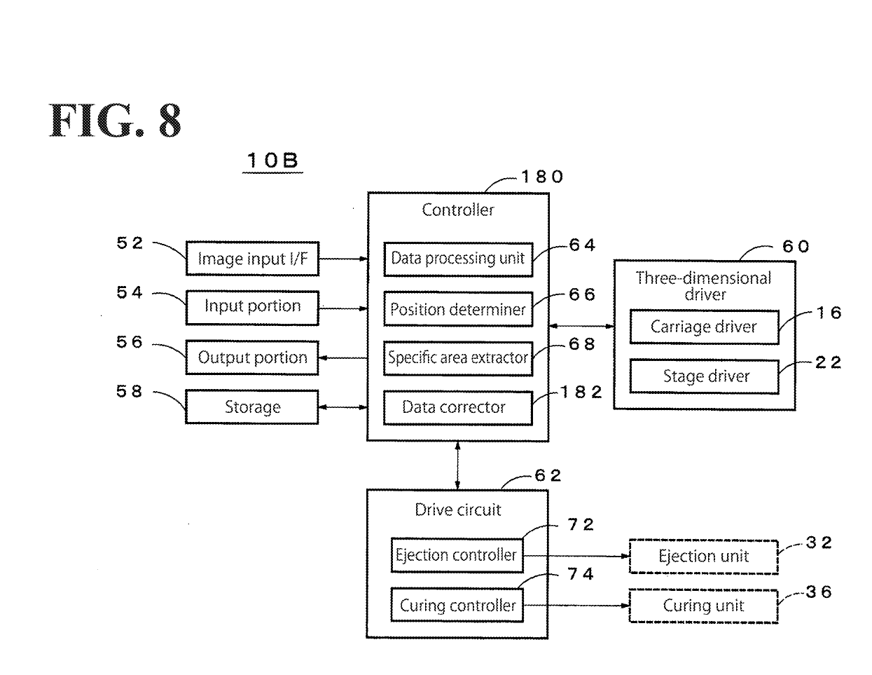

Next, a three-dimensional object forming apparatus 10B according to a second embodiment is described by referring to FIGS. 8 to 10.

### Electrical Block Diagram of Three-dimensional Object Forming Apparatus 10B

FIG. 8 is an electrical block diagram of the three-dimensional object forming apparatus 10B according to the second embodiment. The configuration of the three-dimensional object forming apparatus 10B is different from that in the first embodiment (the controller 50 in FIG. 2) in an operation and a function of a controller 180. Specifically, the controller 180 can read out and execute a program stored in the storage 58 to implement functions including the data processing unit 64, the position determiner 66, the specific area extractor 68, and a data corrector 182 (roughener).

### Operation of Three-dimensional Object Forming Apparatus 10B

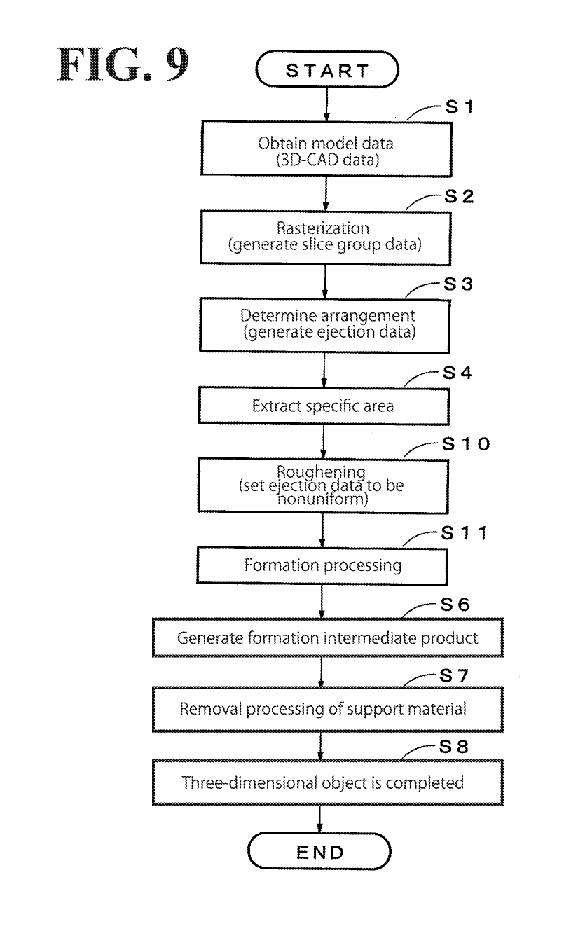

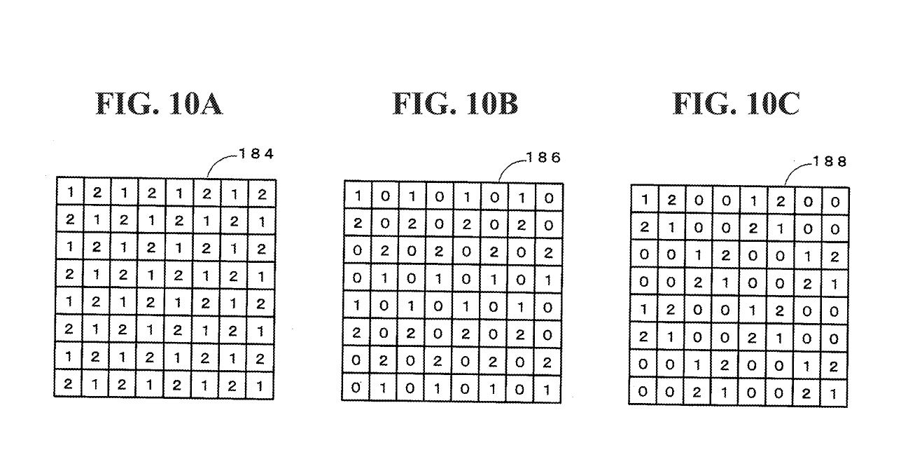

Next, an operation of the three-dimensional object forming apparatus 10B illustrated in FIG. 8, that is, an operation of generating the three-dimensional object 100 is described with reference to the flowchart in FIGS. 9 and 10 as appropriate.

The controller 180 obtains the model data through the image input I/F 52 (step S1). The data processing unit 64 rasterizes the model data in a vector data format (step S2). The position determiner 66 determines the position of the build material 104 and the position of the support material 106 (step S3). The specific area extractor 68 extracts the specific areas 136 and 138 from the outer surface 112 formed of the build material 104 (step S4).

At step S10, the data corrector 182 partially corrects the ejection data used for controlling the ejection by the ejection unit 32 to set nonuniform voxel values in the specific areas 136 and 138.

FIGS. 10A to 10C are diagrams illustrating how nonuniform ejection data is set. Specifically, FIG. 10A is a schematic view of normal ejection data. FIG. 10B is a first schematic view of the ejection data used for roughening. FIG. 10C is a second schematic view of the ejection data used for roughening.

A uniform area 184 illustrated in FIG. 10A is a plane coordinate matrix including 8 (longitudinal direction)×8 (lateral direction) voxels. The number in each voxel indicates a voxel value identifying the type of the build material 104. Specifically, the values “1”, “2”, and “0” respectively correspond to cyan, magenta, and a position where no droplet is ejected. The uniform area 184 includes no value “0”, whereby the droplets 30 are ejected to form a uniform color (a secondary color based on cyan and magenta).

A nonuniform area 186 illustrated in FIG. 10B has basic units arranged in a checkered pattern. The basic units include “1×2 cells” (a combination of the values “1” and “2”) and “1×2 cells” (including the value “0” only). A nonuniform area 188 illustrated in FIG. 10C has basic units arranged in a checkered pattern. The basic units include “2×2 cells” (a combination of the values “1” and “2”) and “2×2 cells” (including the value “0” only). The checkered pattern in FIG. 10C has a larger basic unit than that in FIG. 10B, and thus is likely to result in a larger surface roughness.

At step S11, the three-dimensional object forming apparatus 10B performs formation processing based on the ejection data corrected at step S10. Specifically, the three-dimensional object forming apparatus 10B forms the slice multilayer structure 102 by sequentially depositing the unit layers 151 to 157, including the build material 104 and the support material 106, in the Z direction with the stage 20 and the ejection unit 32 moving relative to each other in the three-dimensional directions. This processing does not involve the processing of changing the ejection control condition in accordance with the attribute of the specific areas 136 and 138 performed in the first embodiment.

As a result of the processing, slice multilayer structure 102 in the completed state is obtained as the formation intermediate product 120 (step S6). Finally, the processing of removing the support material 106 from the formation intermediate product 120 is performed (step S7). Thus, the three-dimensional object 100 is completed with high finishing quality (step S8).

### Advantageous Effects of Three-Dimensional Object Forming Apparatus 10B

The three-dimensional object forming apparatus 10B having the configuration described above ensures the same or similar effects as the first embodiment (three-dimensional object forming apparatus 10A). Thus, higher finishing quality in terms of surface glossiness can be achieved regardless of the outer shape of an object.

The three-dimensional object forming method using the three-dimensional object forming apparatus 10B includes determining the position of the build material 104 and the position of the support material 106 (step S3) and roughening the specific areas 136 and 138 (step S10).

The three-dimensional object forming apparatus 10B further includes the ejection unit 32 that ejects the droplets 30 of the build material 104 and the support material 106. The roughener is the data corrector 182 that sets the ejection data, used for the ejection control for the ejection unit 32, to be nonuniform for the specific areas 136 and 138. Thus, the roughening for the specific areas 136 and 138 is executable in the processing of generating the ejection data.

### Third Embodiment

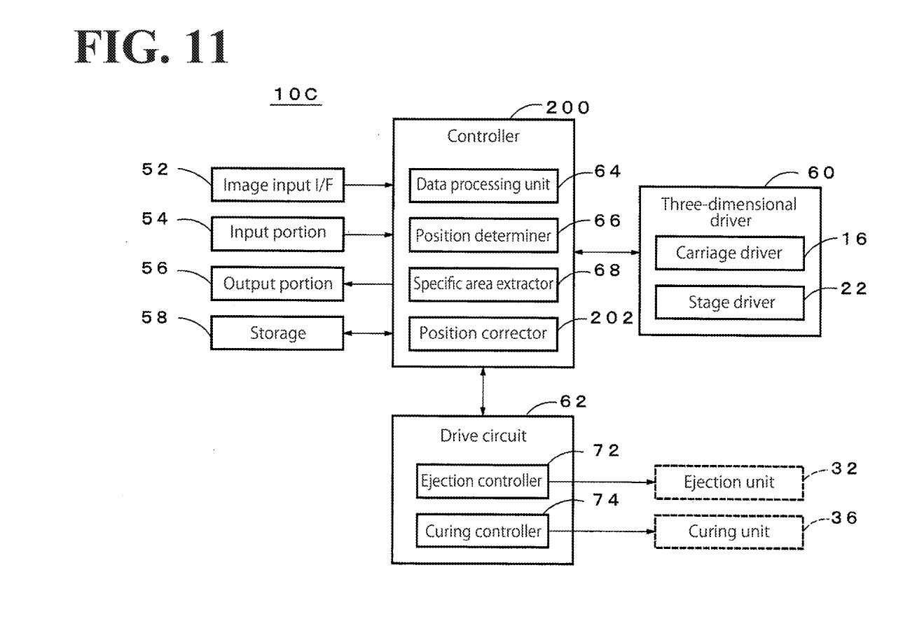

Next, a three-dimensional object forming apparatus 10C according to a third embodiment will be described below by referring to FIGS. 11 to 13. Electrical Block Diagram of Three-dimensional Object Forming Apparatus 10C

FIG. 11 is an electrical block diagram of the three-dimensional object forming apparatus 10C according to the third embodiment. The configuration of the three-dimensional object forming apparatus 10C is different from that in the first embodiment (the controller 50 in FIG. 2) in an operation and a function of a controller 200. Specifically, the controller 200 can read out and execute a program stored in the storage 58 to implement functions including the data processing unit 64, the position determiner 66, the specific area extractor 68, and a position corrector 202 (roughener).

### Operation of Three-Dimensional Object Forming Apparatus 10C

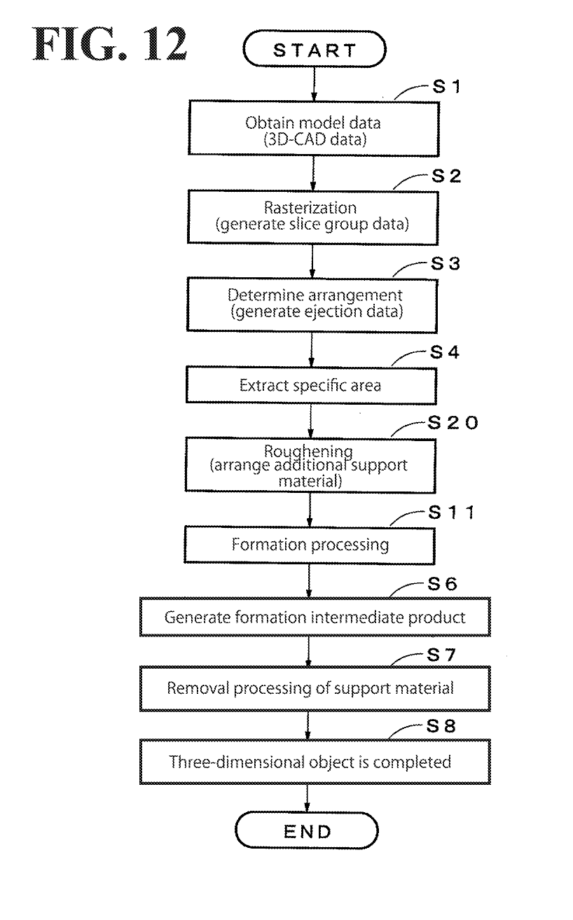

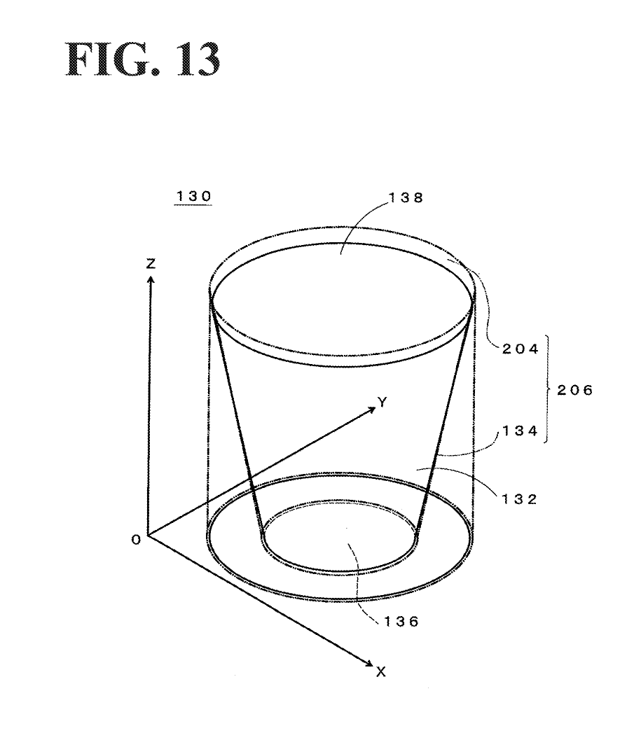

Next, an operation of the three-dimensional object forming apparatus 10C illustrated in FIG. 11, and in particular, an operation to generate the three-dimensional object 100 is described by referring to the flowchart in FIGS. 12 and 13 as appropriate.

The controller 200 obtains the model data through the image input I/F 52 (step S1). The data processing unit 64 rasterizes the model data in a vector data format (step S2). The position determiner 66 determines the position of the build material 104 and the position of the support material 106 (step S3). The specific area extractor 68 extracts the specific areas 136 and 138 from the outer surface 112 formed of the build material 104 (step S4).

At step S20, the position corrector 202 adds the support material 106 to a position covering the specific area 138, to the position determined at step S3, as described below in detail by referring to FIG. 13.

FIG. 13 is a diagram illustrating how the additional support material 106 is arranged. The definition of the work area 130 is the same as that in FIG. 5, and will not be elaborated upon here. A closed space illustrated with solid lines represents a build area 132 indicating the three-dimensional position of the build material 104. A closed space illustrated with broken lines represents a support area 134 indicating the three-dimensional position of the support material 106.

The position corrector 202 determines whether any one of the specific areas 136 and 138, extracted by the specific area extractor 68, is not covered with the support material 106. In the illustrated example, the specific area 138 is determined to be not covered. Thus, the position corrector 202 additionally arranges the support material 106, with a predetermined thickness, at a position to cover the specific area 138. This results in a corrected supported area 206 including the support area 134 and an additional area 204.

At step S11, the three-dimensional object forming apparatus 10C performs formation processing based on the ejection data corrected at step S20. This processing also does not involve the processing of changing the ejection control condition in accordance with the attribute of the specific areas 136 and 138 performed in the first embodiment.

As a result of the processing, slice multilayer structure 102 in the completed state is obtained as the formation intermediate product 120 (step S6). Finally, the processing of removing the support material 106 from the formation intermediate product 120 is performed (step S7). Thus, the three-dimensional object 100 is completed with high finishing quality (step S8). The tops surface 116 covered with the support material 106 to be roughened has an approximately the same level of surface roughness as the bottom surface 114 and the side surface 118.

### Advantageous Effects of Three-Dimensional Object Forming Apparatus 10C

The three-dimensional object forming apparatus 10C having the configuration described above also ensures the same or similar effects as the first embodiment (three-dimensional object forming apparatus 10A). Thus, higher finishing quality in terms of surface glossiness can be achieved regardless of the outer shape of an object.

The three-dimensional object forming method using the three-dimensional object forming apparatus 10C includes determining the position of the build material 104 and the position of the support material 106 (step S3) and roughening the specific areas 136 and 138 (step S20).

In the method, the roughener of the three-dimensional object forming apparatus 10C is the position corrector 202 that additionally arranges the support material 106 at a position to cover the specific area 138. Thus, the roughening for the specific areas 136 and 138 is executable in the processing of arranging the build material 104 and the support material 106.

### Additional Notes

The present invention is not limited to the embodiments described above, and can be modified without departing from the gist of the present invention.

In the embodiments described above, the stage 20 and the ejection unit 32 are both movable. Alternatively, one of the stage 20 and the ejection unit 32 may be movable relative to the other one being unmovable. Any combination among the three movement directions (the X direction, the Y direction, and the Z direction) may be employed.

The three-dimensional object forming apparatus 10 in the embodiments employs an inkjet method. However, the method is not limited to this. Non-limiting examples of other methods that can be employed include fused deposition modeling, optical modeling, selective laser sintering, projection, and inkjet powder layering.
10 (A, B, C) three-dimensional object forming apparatus
12 . . . stage unit
14 . . . carriage
16 . . . carriage driver
18 . . . work surface
20 . . . stage
22 . . . stage driver
24 . . . guide rail
26 . . . slider
28 . . . carriage rail
30 . . . droplet
32 . . . ejection unit
34 . . . flattening roller
36 . . . curing unit
38, 40 . . . ejection head
42 . . . nozzle
44 . . . nozzle array
50, 180, 200 . . . controller
60 . . . three-dimensional driver
62 . . . drive circuit
64 . . . data processing unit
66 . . . position determiner
68 . . . specific area extractor
70 . . . specific area designator
72 . . . ejection controller (roughener)
74 . . . curing controller
100 . . . three-dimensional object
102 . . . slice multilayer structure
104 . . . build material
106 . . . support material
108 . . . slice surface
110 . . . main body
112 . . . outer surface
120 . . . formation intermediate product
122 . . . support
130 . . . work area
132 . . . build area
134 . . . support area
136, 138 . . . specific area
139 . . . contact area
140, 184 . . . uniform area
146, 148, 186, 188 . . . nonuniform area
151 to 157 . . . unit layer
182 . . . data corrector (roughener)
202 . . . position corrector (roughener)
204 . . . additional area
206 . . . corrected support area

What is claimed is:

1. A three-dimensional object forming apparatus configured to form a three-dimensional object in such a manner that from a formation intermediate product obtained by sequentially depositing unit layers each comprising a build material and/or a support material on a work surface, a support made of the support material is removed, whereby the three-dimensional object is made of the build material, the three-dimensional object forming apparatus comprising:
a position determiner configured to determine a position of the build material and a position of the support material so as to make a partial surface contact between the three-dimensional object and the support; and
a roughener configured to roughen a specific area defined by an outer surface among outer surfaces of the build material located at the position determined by the position determiner, the outer surface being parallel with the work surface.

2. The three-dimensional object forming apparatus according to claim 1, wherein the roughener is configured to roughen the specific area not covered with the support material.

3. The three-dimensional object forming apparatus according to claim 2, wherein the roughener is configured to roughen the specific area adjacent to an area covered with the support material.

4. The three-dimensional object forming apparatus according to claim 1, further comprising an ejection unit configured to eject droplets of the build material and the support material,
wherein the roughener is an ejection controller configured to control the ejection unit to set at least one of an ejection density, an ejection amount, and an ejection speed of the droplets for the specific area to be nonuniform.

5. The three-dimensional object forming apparatus according to claim 1, further comprising an ejection unit configured to eject droplets of the build material and the support material,
wherein the roughener is a data corrector configured to set ejection data used for ejection control for the ejection unit to be nonuniform for the specific area.

6. The three-dimensional object forming apparatus according to claim 2, wherein the roughener is a position corrector configured to additionally arrange the support material at a position to cover the specific area.

7. A three-dimensional object forming method using a three-dimensional object forming apparatus that is configured to form a three-dimensional object in such a manner that from a formation intermediate product obtained by sequentially depositing unit layers each comprising a build material and/or a support material on a work surface, a support made of the support material is removed, whereby the three-dimensional object is made of the build material, the three-dimensional object forming method comprising:
determining a position of the build material and a position of the support material so as to make a partial surface contact between the three-dimensional object and the support; and
roughening a specific area defined by an outer surface among outer surfaces of the build material located at the position determined by the position determiner, the outer surface being parallel with the work surface.

8. The three-dimensional object forming method according to claim 7, wherein the roughening step comprises roughening the specific area not covered with the support material.

9. The three-dimensional object forming method according to claim 8, wherein the roughening step comprises roughening the specific area adjacent to an area covered with the support material.

10. The three-dimensional object forming method according to claim 7, further comprising ejecting droplets of the build material and the support material with an ejection unit of the three-dimensional object forming apparatus,
wherein the roughening step comprises controlling the ejection unit to set at least one of an ejection density, an ejection amount, and an ejection speed of the droplets for the specific area to be nonuniform.

11. The three-dimensional object forming method according to claim 7, further comprising ejecting droplets of the build material and the support material with an ejection unit of the three-dimensional object forming apparatus,
wherein the roughening step comprises setting ejection data used for ejection control for the ejection unit to be nonuniform for the specific area.

12. The three-dimensional object forming method according to claim 8, wherein the roughening step comprises additionally arranging the support material at a position to cover the specific area.

13. A forming intermediate product formed by using the three-dimensional object forming method according to claim 7.

14. A three-dimensional object formed by removing the support from the formation intermediate product formed by using the three-dimensional object forming method according to claim 7.

15. The three-dimensional object forming apparatus according to claim 2, further comprising an ejection unit configured to eject droplets of the build material and the support material,
wherein the roughener controls the ejection unit to set at least one of an ejection density, an ejection amount, and an ejection speed of the droplets for the specific area to be nonuniform.

16. The three-dimensional object forming apparatus according to claim 3, further comprising an ejection unit configured to eject droplets of the build material and the support material,
wherein the roughener controls the ejection unit to set at least one of an ejection density, an ejection amount, and an ejection speed of the droplets for the specific area to be nonuniform.

17. The three-dimensional object forming apparatus according to claim 2, further comprising an ejection unit configured to eject droplets of the build material and the support material,
wherein the roughener is a data corrector configured to set ejection data used for ejection control for the ejection unit to be nonuniform for the specific area.

18. The three-dimensional object forming apparatus according to claim 3, further comprising an ejection unit configured to eject droplets of the build material and the support material,
wherein the roughener is a data corrector configured to set ejection data used for ejection control for the ejection unit to be nonuniform for the specific area.

19. The three-dimensional object forming apparatus according to claim 3, wherein the roughener is a position corrector configured to additionally arrange the support material at a position to cover the specific area.

20. The three-dimensional object forming method according to claim 8, further comprising ejecting droplets of the build material and the support material with an ejection unit of the three-dimensional object forming apparatus,
wherein the roughening step includes controlling the ejection unit to set at least one of an ejection density, an ejection amount, and an ejection speed of the droplets for the specific area to be nonuniform.
